(19) United States
(12) Patent Application Publication
(10) Pub. No.: US 2026/0283342 A1
(43) Pub. Date: Sep. 24, 2026

(54) BRUSH ASSEMBLY, ROTARY BRUSH TOOL AND METHOD OF OPERATING SAME

(71) Applicant: Sander Hendrikus Johannes HOFSTEE, Wervik (BE)

(72) Inventor: Sander Hendrikus Johannes HOFSTEE, Wervik (BE)

(21) Appl. No.: 19/574,307

(22) Filed: Mar. 21, 2026

(30) Foreign Application Priority Data
Mar. 21, 2025 (EP) 25165458.8

(51) Int. Cl. A46B 15/00; A46B 5/00; A46B 13/00

(52) U.S. Cl. CPC A46B 15/0051; A46B 13/001; A46B 5/0095

(57) ABSTRACT

A brush assembly comprises a brush holder rotatably drivable about an axis and an annular brush mechanically coupled or couplable to the brush holder for joint rotation therewith and having an annular bristle array of radially outwardly projecting bristles. This brush holder is formed with axially throughgoing with holes for air ventilation and cooling. According to the invention there are respective air scoops at least partially covering the holes and generating an axially flowing air stream through the bristle holder.

### FIELD OF THE INVENTION

The present invention relates to a brush assembly. More particularly this invention concerns such a brush assembly, a rotary brush tool, and a method of operating the tool.

### BACKGROUND OF THE INVENTION

A known brush assembly comprises a rotatably drivable brush holder and an annular brush mechanically coupled or couplable to the brush holder and having an annular bristle array with bristles projecting radially outward. The brush holder being provided with holes for air ventilation and cooling.

Such a brush assembly or the annular brush driven by it is typically used to abrasively treat surfaces of workpieces. This allows the surface in question to be prepared for subsequent treatment with a coating, paint, or other substance. In this context, it is possible, among other things, to intensify the impact on the surface in question by a stop engaging in the annular bristle array, as explained in detail in applicant's prior art according to U.S. Pat. No. 9,554,642.

In this context, the annular brush usually consists of a brush band and the bristles connected to it. This generates a not inconsiderable amount of heat due to friction in the known teaching. First of all, contact with the surface of the workpiece to be processed causes the brush belt, together with the bristles connected to it and forming the annular bristle array, to rub inside the brush holder. In addition, such rubbing is also caused and supported by the fact that the bristles run over the stop and are slowed down for a certain time. This allows the kinetic energy stored in this way to be used by the bristles to also impact the surface of the workpiece after they are released.

In any case, considerable thermal stresses on the brush band as well as on the bristles or, in general, on the annular brush are observed in practice. This can be problematic if the bristle band and/or the bristles are made of plastic. Such plastics generally have only a limited thermal load capacity, which is explained by the fact that the melting point of such plastics is generally below 200° C.

For this reason, the prior art according to GB 2,268,682 provides holes in the bristle holder for air circulation and cooling. These holes can be designed as slots running radially or as elongated, mostly rectangular holes. In the latter case, upward and downward facing fins are also provided on the opposite narrow sides and are supposed to provide axial ventilation and thus cooling.

The above-described prior art has proven itself in principle, but relies on bristles that are firmly anchored in the brush holder. This makes it practically impossible to replace the bristles when they wear out.

Furthermore, it is already known in the prior art, for example according to applicant's EP 1,688,061, to use a pneumatic drive for cooling in a rotary brush tool. In fact, the procedure here is such that exhaust air from the pneumatic drive is supplied to the brush holder and/or the annular brush as a cooling medium. Alternatively, however, a separate compressed-air supply for the pneumatic drive can also be provided with a branched fresh air line that is directed toward the brush holder and/or the annular brush, thereby supplying fresh air as a cooling medium. However, such a design has the disadvantage that a pneumatic supply is required and, for example, electric drives cannot be used for this purpose. This is where the invention comes in.

### OBJECTS OF THE INVENTION

It is therefore an object of the present invention to provide an improved brush assembly in such a way that the annular brushes can be easily replaced and proper cooling is ensured.

### SUMMARY OF THE INVENTION

A brush assembly comprises a brush holder rotatably drivable about an axis and an annular brush mechanically coupled or couplable to the brush holder for joint rotation therewith and having an annular bristle array of radially outwardly projecting bristles. This brush holder is formed with axially throughgoing with holes for air ventilation and cooling. According to the invention there are respective air scoops at least partially covering the holes and generating an axially flowing air stream through the bristle holder. In other words, the air scoops extend axially over the respective holes, at least in part or partially.

The invention is based on the discovery that air scoops that axially overlie the respective holes in the brush holder can be used to generate a particularly effective air flow inside the brush holder. The air scoop is generally an air intake that, like an air scoop on a motor-vehicle hood, uses the entry of air through the vehicle movement or here the rotation of the brush holder in the present brush assembly. In other words, the rotation of the brush holder in the working direction of the annular brush mechanically coupled or couplable to the brush holder ensures that air is diverted into the corresponding hole of the brush holder via the respective air scoop. The air stream generated in this way inside the brush holder now generally flows axially through the brush holder, i.e. parallel to an axis of rotation of the brush holder and thus also of the annular brush accommodated therein.

Since, in addition, the annular brush is or can be coupled to the brush holder in a removable and replaceable manner, the annular brush can be replaced and exchanged as required, on the one hand, and, on the other hand, there is proper coupling of the annular brush inside the brush holder. In fact, the invention's coupling system reduces the temperature of the ring bushings by 5° C. or more compared to a system without ventilation and air circulation protection. In principle, even greater temperature reductions can be achieved, which can for example amount to 6° C. and more.

In this context, the annular brush generally consists of a bristle band shaped as a ring on the one hand and bristles connected to the bristle band on the other. In addition, the brush holder is usually designed to be at least two parts and formed from two disks or end plates spaced from each other and securing the annular brush axially. In most cases, a spacer surrounded by the annular brush is also provided, which ensures the spacing of the two end plates when assembled and at the same time supports the mounting and mechanical coupling of the annular brush with the brush holder. In addition, one or more axial webs may also be provided on one or both end plates engaging through gaps in the annular bristle array and ensuring the mechanical coupling between the annular brush on the one hand and the brush holder on the other during their joint rotation around the axis of rotation in the working direction.

In principle, the annular brush can also be designed with a brush core that is not in the form of a bristle band but rather as a solid body made for example from an elastic plastic. In this case, the bristles are embedded or anchored in the brush core on all sides. In this case, too, the annular brush can be fitted inside of the brush holder in a removable and replaceable manner and mechanically coupled to it. At the same time, the holes in the brush holder for air circulation and cooling again ensure that the brush holder, which in this case is solid, is cooled in a similar manner to the brush band with the bristles attached radially thereto.

According to an advantageous design, each air scoop is open at least in the rotation direction of the brush holder. As a result, in this direction of rotation, air is scooped into the interior of the brush holder through the holes of the respective air scoops, where it generates the desired axially flowing air stream through the brush holder to ensure the cleaning of the annular brushes. This not only causes the bristle band to be cleaned, but also the bristles radially anchored to the bristle band.

The holes in the brush holder may be rectangular with curved narrow ends. In addition, the design is usually such that each air scoop predominantly covers the respective hole in the brush holder when viewed from above. In most cases, the invention works in this context with a coverage of approximately 50% to 80%. In other words, the air scoops cover approximately 50% to 80% and preferably approximately 60% of the respective holes when viewed from above. This is, of course, only an example and is by no means restrictive.

In addition, the design is such that the air scoop ends at the trailing end of the corresponding hole in the rotation direction. As a result, the leading end of the air scoop acts as a funnel-shaped intake open in the rotation direction for the air scooped in, which is then deflected axially at the trailing end of the air scoop and thus the respective hole, thereby ensuring the desired axially flowing air stream inside the brush holder.

For ergonomic reasons, the design is also such that each air scoop has an arched hole at its leading end in the rotation direction. In fact, the arched shape in this context ensures that no burrs are observed in this area. This is particularly advantageous in view of the fact that the scoops generally cover the respective holes axially and thus project axially from the respective end plate generally realized in this context, thereby posing a certain risk of injury to an operator.

This risk is reduced and minimized by the fact that the air scoop has the curved hole in question at its leading end in the rotation direction, thus avoiding any burrs or other sharp points or edges. In fact, the end plates and thus the brush holder are usually manufactured as injection-molded metal parts, which can then be subjected to further machining operations such as drilling or milling. This explains any burrs or sharp edges, which are avoided in the invention.

As already explained above, the brush holder generally consists of at least two parts formed by the two end plates spaced apart from each other and axially securing the annular brushes. The end plates themselves are as the name suggests flat or largely flat. This allows the band to be held interchangeably inside the brush holder and replaced if necessary. In this context, the usual procedure is to equip at least one plate with holes and respective air scoops. The term “outer end plate” refers to the end plate of the two end plates that is not located on the drive side. In other words, the outer end plate of the brush holder faces outward, while the inner end plate is generally provided with a drive shaft in order to be able to use a corresponding drive for rotating the brush holder and thus the bristle assembly as a whole.

According to a further advantageous design, both the inner and outer end plates are provided with holes and corresponding air intakes. In addition, the design is such that the holes in question on the opposing end plates are also axially opposite. This allows the air drawn in by the air intake vents on the outer end plate to not only pass through the brush holder axially, but also to leave the brush holder again at the opposite inner end plate through the holes provided there. This results in an axial air flow through the interior of the brush holder, which coincides with the axis of rotation of the brush holder and thus also of the annular brush.

In this context, it has also proven to be particularly advantageous if the air scoops on the leading end plate are open in the rotation direction of the brush holder, thereby creating a kind of suction pressure, while the air intake ducts on the inner end plate are open oppositely to the rotation direction. The opposite hole of the air scoops on the inner end plate in relation to the rotation direction ensures that negative pressure and thus a certain suction effect is generated in this direction of rotation at the air scoops in question on the inner end plate. This further intensifies and strengthens the axially flowing air stream through the brush holder.

The invention also relates to a rotary brush tool provided with a machine housing and a drive for the brush assembly. In fact, the drive ensures that the brush assembly in question is rotated.

Furthermore, the invention relates to a method of operating a brush assembly as described above. During operation of the brush assembly in question, the axially flowing air stream described above is generated through a respective hole with an air scoop that extends at least partially in the axial direction. This axially flowing air stream generated by the brush holder advantageously flows transversely to the bristle band as part of the annular brush. In addition, the air stream running transversely to the bristle band generally ensures that the bristle band is exposed to the air stream above and below. The air stream is self-regulating due to the negative pressure described above and the respective suction effect on the one hand, and the positive pressure generated on the other. As a result, both the bristle band and the bristles anchored in the bristle band are cooled by the air passing through the brush holder. In practice, the bristles are generally U-shaped bristles that are inserted into corresponding slots in the bristle band and anchored therein.

Due to the fact that the air scoops on the outer end plate have the mouths facing in the rotation direction and on the inner end plate with the holes facing oppositely to the rotation direction, one observes, on the holes in question of the opposing end plates of the brush holder, positive pressure on one side and negative pressure on the other, which is generated in this area in each case. In this case, there is positive pressure at the air intake ducts on the outer end plate that are open in the rotation direction, whereas negative pressure is generated at the air intake ducts with the hole opposite to the rotation direction of the inner end plate. This alternating pressure, on the one hand in the form of positive pressure and on the other hand in the form of negative pressure, ensures a pronounced air stream through the brush holder in the axial direction and an intensive cooling effect that has not been seen before in the prior art. This applies in particular in connection with the annular brush accommodated in a removable and replaceable manner inside the brush holder. These are the main advantages.

### BRIEF DESCRIPTION OF THE DRAWING

The above and other objects, features, and advantages will become more readily apparent from the following description, reference being made to the accompanying drawing in which:

FIG. 1 is a perspective view of the brush assembly according to the invention;

FIG. 1A is a large-scale view of a detail of FIG. 1;

FIG. 2 is a schematic view of the brush assembly in conjunction with a rotary brush tool; and

FIG. 3 shows the axially flowing air stream observed inside a brush holder according to the invention.

### SPECIFIC DESCRIPTION OF THE INVENTION

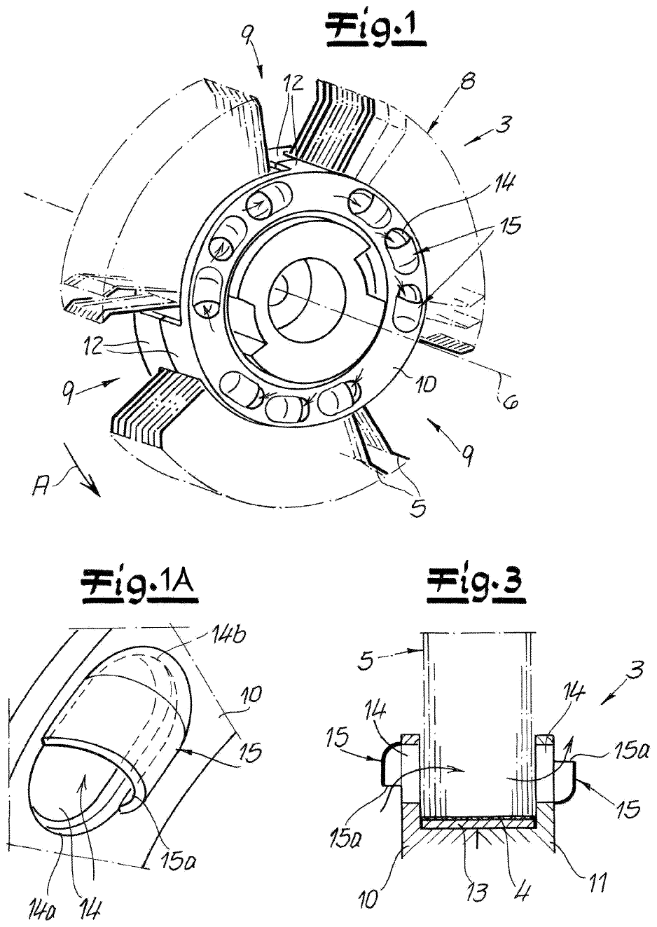

As seen in the drawing, a brush assembly is used in conjunction with a rotary brush tool, a machine housing 1, and a drive 2, which is only indicated schematically and accommodated therein for the brush assembly 3 in question. The drive 2 ensures that the brush assembly 3 is set in rotation in a rotation direction A about an axis 6 as shown in FIG. 1, which, according to the embodiment, corresponds to a counterclockwise movement around this axis 6 of rotation.

In fact, the brush assembly 3 has an annular brush 4, 5 that in this embodiment and without limitation comprises an annular bristle band 4 and bristles 5 connected thereto and projecting radially outward. The band 4 is rectangular and elongated in its preassembled state, with the ends of the band 4 being connected to each other when assembled so that the band 4 is annular as shown in FIG. 1. In use the annular band 4 is centered on the axis.

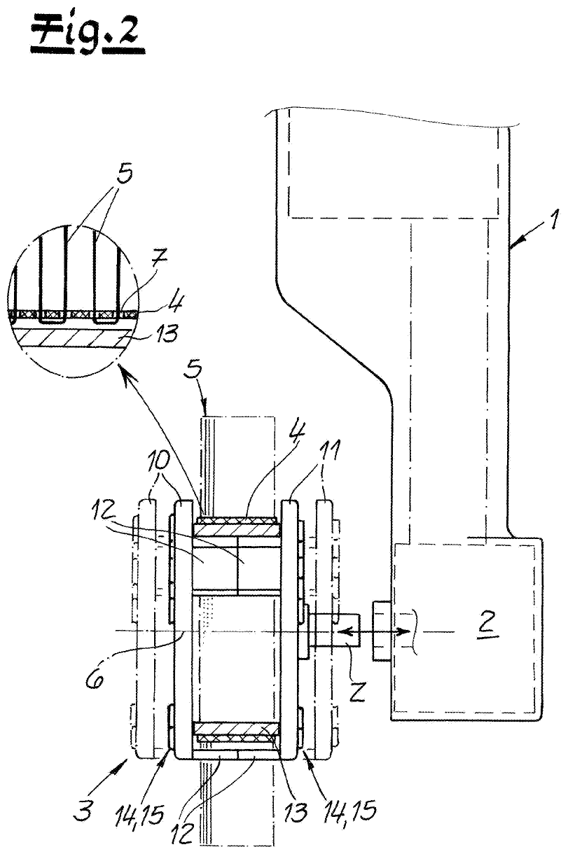

The bristles 5 extend generally radially from the axis of rotation 6. They are U-shaped and made of steel and/or plastic, like a staple. For this purpose, the bristles 5 are inserted into mounting holes 7 in the band 4 as only shown in FIG. 2 and anchored therein. The band 4 can be made of a plastic fabric, for example polyamide, with or without a coating. Here, the bristles 5 outer tips that are angled in the rotation direction A, which is of course is only an example and by no means mandatory. According to the embodiment, the bristles 5 form an annular bristle array 8 with axially open and angularly spaced gaps 9. Webs extend axially between outer and inner end plates 10 and 11 that are circular, parallel to each other, and that form a brush holder 10, 11 with which the annular brush 4 is mechanically coupled or can be coupled. The annular brushes 4, 5 can actually be replaced by taking off one of the end plates 10, 11, as shown in dot-dash lines in FIG. 2.

In addition to the two end plates 10, 11, a spacer sleeve 13 may also be provided that is fitted coaxially inside the band 4, is shaped like a ring when assembled, and determines the axial spacing between the two end plates 10, 11. It can be seen that the outer end plate 10 is remote from the drive 2 and the inner end plate 11 is closer to it. The inner end plate 11 carries a drive pin Z that is rotated by the drive 2 in order to apply rotational force in the rotation direction A to the entire brush assembly 3 or the end plates 10, 11 together with the annular brushes 4, 5 accommodated therein, for rotation in the direction A. The drive pin Z extends on or parallel to the axis of rotation 6 of the brush assembly 3 and thus of the brush holder 10, 11 as well as the ring brushes 4, 5.

Of particular importance for the invention is that the end plates 10 and 11 have axially throughgoing holes 14 that provide air ventilation and cooling of the band 4 and the bristles 5. In fact, the holes 14 are each provided with a respective axially outwardly projecting air scoop 15 in accordance with the invention. This creates a largely axially flowing air stream through the brush holder 10, 11, which can best be understood by referring to FIG. 3.

FIG. 1 in particular shows that each air scoop 15 is open at a leading end in the rotation direction A of the brush holder 10, 11. Otherwise, the air scoop 15 is closed or cuboid in shape with a base formed by the respective hole 14. In addition, the hole 14 with the respective air scoop 15 in the brush holder 10, 11 is rectangular with curved ends 14a and 14b. Each hole 14 extends predominantly angularly relative to the rotation axis 6.

FIG. 1 also shows that the air scoop 15 in question mainly covers the respective hole 14 when viewed parallel to the axis of rotation 6. In fact, each air scoop 15 covers approximately 60% of the respective hole 14. Furthermore, it can be seen that each air scoop 15 terminates at a trailing end 14b of the respective hole 14 in the rotation direction of travel A. In contrast, the leading end 14a of the respective hole 14 is open, so that air is scooped into the interior of the brush holder 10, 11 of the brush assembly 3 in the rotation direction A when the brush holder 10, 11 or the brush assembly 3 is spinning. In addition, the design at this leading end of the air scoop 15 is such that an arcuate leading mouth 15a can be observed here in order to prevent any injuries.

In fact, the arcuate mouth 15a is the leading end of the air scoop 15 in the rotation direction A. Since the air scoop 15 only partially covers the corresponding hole 14 in the respective end plate 10, 11, the mouth 15a in question in the air scoop 15 and the front area of the hole 14 in the end plate 10, 11 together define a three-dimensional funnel 14, 15a for supplying air.

A comparison of FIGS. 1, 2, and 3 shows that both the inner end plate 11 and the outer end plate 10 are provided with respective holes 14 and respective air scoops 15. The holes 14 in question are located axially opposite each other on the end plates 10, 11, as can best be seen in FIG. 3. A comparison of FIGS. 1 and 3 also shows that the air vent hoods 15 on the front plate 10 open in radially inward toward the axis 6 of the brush holder 10, 11, whereas the air intake ducts 15 on the inner end plate 11 are open oppositely. This is, of course, only an example.

In this way, a negative pressure is generated in the area of the air intake ducts 15 on the outer end plate 10 that are open into in the rotation direction A. In contrast, it can be observed that a negative pressure is generated in the area of the air intake ducts 15 of the inner end plate 11, which are open oppositely to the rotation direction A, when the brush assembly 3 is in operation. As a result, the axially flowing air stream between the bristles 5 shown in FIG. 3 is formed. In fact, the air stream is characterized by the fact that it predominantly passes through the end plates 10, 11 in or parallel to the rotation axis 6, with an air intake in the area of positive pressure at the air scoops 15 of the outer end plate 10 and an air output in the area of negative pressure at the air scoops 15 of the inner end plate 11.

The end plates 10, 11 and thus the brush holder 10, 11 can be made entirely of steel or aluminum or even plastic. The same applies to the bristles 5. The band 4 is generally a fabric band made for example of polyamide that can also be reinforced with a polyurethane coating. Of course, other designs are also conceivable. In addition, a stop can be provided that dips into the annular bristle array 8, as described in detail in U.S. Pat. No. 9,554,642. However, this is not shown here.

1. A brush assembly comprising:
a brush holder rotatably drivable about an axis;
an annular brush mechanically coupled or couplable to the brush holder for joint rotation therewith and having an annular bristle array of radially outwardly projecting bristles, the brush holder being formed with axially throughgoing with holes for air ventilation and cooling; and
respective air scoops at least partially covering the holes and generating an axially flowing air stream through the bristle holder.

2. The brush assembly according to claim 1, wherein each air scoop is open angularly at least in the rotation direction of the brush holder.

3. The brush assembly according to claim 1, wherein each hole is rectangular with curved narrow ends.

4. The brush assembly according to claim 1, wherein each air scoop covers most but not all of the respective hole when viewed axially.

5. The brush assembly according to claim 4, wherein each air scoop covers approximately 60% of the respective hole.

6. The brush assembly according to claim 1, wherein each air scoop terminates at a closed trailing end of the respective hole in the rotation direction.

7. The brush assembly according to claim 1, wherein each air scoop has an arcuate intake hole at a leading end in the rotation direction.

8. The brush assembly according to claim 1, wherein the brush holder is formed by inner and outer end plates spaced axially apart from each other and axially flanking the annular brushes.

9. The brush assembly according to claim 8, wherein at least the outer end plate is provided with holes and respective air scoops.

10. The brush assembly according to claim 8, wherein both the inner end plate and the outer end plate are provided with the holes and the respective air scoops.

11. The brush assembly according to claim 10, wherein the holes on the end plates are axially opposite each other.

12. The brush assembly according to claim 11, wherein the air scoops on the outer end plate open into the rotation direction of the brush holder and the air scoops on the inner end plate open in the opposite direction to the rotation direction.

13. The brush assembly according to claim 1, further comprising:
a housing; and
a drive on the housing rotating the brush holder in the direction of rotation.

14. A method of operating a brush assembly according to claim 1, wherein the generates through the brush holder an axially flowing air and the air stream advantageously flows transversely to and radially inward and outward of an annular band carrying the bristles.

15. The method according to claim 14, wherein the airstream generates a positive pressure on one side of the connections of the opposing end plates of the basket holder and a negative pressure is generated on the other side.
